(19) United States
(12) Patent Application Publication
(10) Pub. No.: US 2022/0094199 A1
(43) Pub. Date: Mar. 24, 2022

(54) A Smart Switch Module and Method for Controlling a Smart Switch Module using a Standard Light Switch

(71) Applicant: Michael Spradley, Richmond, TX (US)

(72) Inventor: Michael Spradley, Richmond, TX (US)

(21) Appl. No.: 17/422,447

(22) PCT Filed: Mar. 13, 2020
(86) PCT No.: PCT/IB2020/052340

§ 371 Date: Jul. 12, 2021

Related U.S. Application Data
(60) Provisional application No. 62/791,867, filed on Jan. 13, 2019.

(51) Int. Cl. H02J 13/00; H05B 47/185; H01H 47/02

(52) U.S. Cl. CPC H02J 13/00036; H02J 13/00007; H05B 47/19; H05B 47/185; H01H 47/02; H02J 13/00026

(57) ABSTRACT

A smart switch module and method of use is described herein. The smart switch module can comprise an enclosure, an AC input terminal, a DC output terminal, a control input terminal, an AC output terminal, all accessible from an exterior of the enclosure, and a relay and microcontroller within the enclosure. The DC output terminal can connect to a supply-side terminal of a standard light switch. The control input terminal can connect to a load-side terminal. The standard light switch can connect and disconnect the supply-side and load-side terminals. The relay can comprise a relay AC output, which can connect with the AC output terminal. The microcontroller can comprise a control input and a control output. The control input can connect to the DC output terminal and can control a state of the relay. The microcontroller can change the state of the relay upon detecting a light switch status change.

### BACKGROUND

This disclosure relates to a smart switch module and method for controlling the smart switch module using a standard light switch. For purposes of this disclosure, such smart switch module and method of use thereof discussed are solely exemplary and not limiting.

In a typical home a standard light switch is used to control devices such as lights, ceiling fans, and other home devices. Standard light switches within homes are most often either single-pole switches or two-pole switches. A single-pole switch has two terminals. A first terminal connects to a live wire energized by a power source, while a second terminal connects to a wire that leads to a device as described above. In a first position, the standard light switch places the first terminal in electrical connection with the second terminal. In a second position, the standard light switch places the first terminal not in electrical connection with the second terminal. A two-pole switch has three terminals. A first terminal connects to a live wire energized by a power source, while a second terminal connects to a first node of a circuit, and a third terminal connects to a second node of a circuit. In a first position, the standard light switch places the first terminal in electrical connection with the second terminal and not in electric connection with the third terminal. In a second position, the standard light switch places the first terminal not in electrical connection with the second terminal and in electrical connection with the third terminal. Most often, two-pole switches are used in homes wherein two standard light switches are used to control one device. For example, a hall light might be controllable by a standard light switch at each end of the hall. Such switches will be two-pole switches.

Another type of standard light switch is a standard dimmer switch. Standard dimmer switches reduce or increase upon manual manipulation the power delivered to a device, usually a light or ceiling fan, causing the intensity of the light or fan to change.

Standard light switches are generally installed in switch boxes in a wall. Switch boxes can house one or more switches. While some switch boxes house a single switch, it is quite common to see switch boxes hold two or more switches, as areas often have two or more devices requiring switching. For example, it is often in each bedroom to have two switches near a door, one for a light and another for a ceiling fan.

Standard light switches can come in many colors and shapes. As a consequence, face plates that cover switch boxes also come in many colors and shapes to match the various standard light switches.

Smart home devices have become more common during recent times, and one of the most sought-after smart home devices includes a Wi-Fi switch module. A Wi-Fi switch module provides wireless control of a device over a wireless network using an electronic device. As presently existing, Wi-Fi switch module replaces a standard light switch. Thus, to use Wi-Fi switch module the standard light switch needs to be taken out from the switch box in a wall. Then, a Wi-Fi switch module is wired and installed in its place. Once installed, Wi-Fi switch module can allow a user to manually control a device using a built-in switch embedded to the Wi-Fi switch module, while also allowing the user to control the device over a Wi-Fi network using an electronic device. Such Wi-Fi switch module can be very effective in manually and wirelessly operating a light. However existing Wi-Fi switch modules on the market have a number of deficiencies. First, as the manual switching mechanism is a built-in, a buyer is limited to the few colors and shapes of the Wi-Fi switch module manufacturer. Although there are a number of Wi-Fi switch manufacturers, design focus tends to focus on technology, choice of color and shape are incredibly limited. As a result, the aesthetic design of Wi-Fi switch module, one installed often does not match the aesthetics of a room or house it is in. As such, replacing only a few standard light switches can break the uniformity of switches in the premises. Furthermore, replacing each of the light switches with the Wi-Fi switch module can be costly. Another difficulty encountered using Wi-Fi switch module is that they can only control a single switch. Therefore, it can be difficult, inconvenient, and expensive to replace two or more standard light switches within a switch panel with Wi-Fi switch modules. Lastly, a Wi-Fi connection itself can sometimes be prone to unintended disconnections from a network, causing preventing control over the network.

As such it would be useful to have an improved system and method for integrating a standard light switch with an improved smart switch module a connectable to a standard light switch module. It would further be advantageous if a smart switch device could control multiple devices. It would be further advantageous to have a two-pole smart switch. It would be further advantageous. It would be further advantageous to have a smart switch connectable to a standard dimmer switch.

### SUMMARY

A smart switch module system and method of use is described herein. The smart switch module can comprise an enclosure, an alternating current (AC) input terminal, a first (DC) output terminal, a first control input terminal, a first AC output terminal, a first relay AC, and a microcontroller. The AC input terminal, the first DC output terminal, the first control input terminal, and the first AC output terminal can be accessible from an exterior of the enclosure. The first DC output terminal can be connectable to a first supply-side terminal of a first standard light switch. The first control input terminal can be connectable to a first load-side terminal of the first standard light switch. The first standard light switch can be capable of connecting and disconnecting the first supply-side terminal to and from the first load-side terminal. The first relay can comprise a first relay AC output, which can be in electrical connection with the first AC output terminal. The microcontroller can be within the enclosure, and can comprise a first control input, a first control output, a memory, and a processor. The first control input can be in electrical connection with the first DC output terminal and can be capable of controlling a first state of the first relay. The memory can comprise an application and data storage. The processor that can, in accordance with the application changes the first state of the first relay upon detecting a first light switch status change.

In another embodiment, a method for controlling a device using a smart switch is described herein. The method for controlling a device using the smart switch can comprise the step of connecting a standard light switch to a smart module. The standard light switch module can comprise a supply-side terminal and a load-side terminal. The first standard light switch can be capable of connecting and disconnecting the first supply-side terminal to and from the first load-side terminal. The smart switch module can comprise an enclosure, an alternating current (AC), a first DC output terminal, a first control input terminal, a first AC output terminal, a first relay, and a microcontroller. The alternating current (AC) input terminal can be accessible from an exterior of the enclosure. The first DC output terminal can be accessible from the exterior of the enclosure. The standard light switch can connect to the smart switch module by connecting the first DC output terminal to the first supply-side terminal. The first control input terminal can be accessible from the exterior of the enclosure. The standard light switch can further connect to the smart switch module by connecting the first control input terminal to the first load-side terminal. The first AC output terminal can be accessible from the exterior of the enclosure. The first relay can comprise a first relay AC output. The first relay AC output can be in electrical connection with the first AC output terminal. The microcontroller can be within the enclosure. The microcontroller can comprise a first control input, a first control output, a memory, and a processor. The first control input can be in electrical connection with the first DC output terminal. The first control output can be capable of controlling a first state of the first relay. The memory can comprise an application and data storage. The processor that can, detect by the microcontroller a first light switch status change of the first standard light switch. And the processor that can change, using the microcontroller, the first state of the first relay upon detecting the first light switch status change.

### BRIEF DESCRIPTION OF THE DRAWINGS

FIG. 1 illustrates a smart switch system.

FIG. 2 illustrates a circuit diagram of a smart switch module that can be used to control power to a single device, the smart switch module with a DOP network interface.

FIG. 3 illustrates a circuit diagram of a smart switch module that can be used to control power to multiple devices, the smart switch module with a DOP network interface.

FIG. 4 illustrates a circuit diagram of a smart switch module that can be used to control power to multiple devices, the smart switch module with a Wi-Fi network interface.

FIG. 5 illustrates a schematic diagram of a microcontroller according to an embodiment of the present disclosure.

FIG. 6 illustrates data store comprising one or more switch addresses and one or more switch statuses.

FIG. 7 illustrates an embodiment of a smart switch module for controlling power to a single device.

FIG. 8 illustrates another embodiment of a smart switch module for controlling power to multiple devices.

FIG. 9 illustrates an embodiment of a smart switch module for multiple light switches.

FIG. 10 illustrates a data over power hub.

FIG. 11 illustrates an exemplary method of operation of a smart switch module.

### DETAILED DESCRIPTION

This disclosure relates to a smart switch module and method for controlling the smart switch module using a standard light switch. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

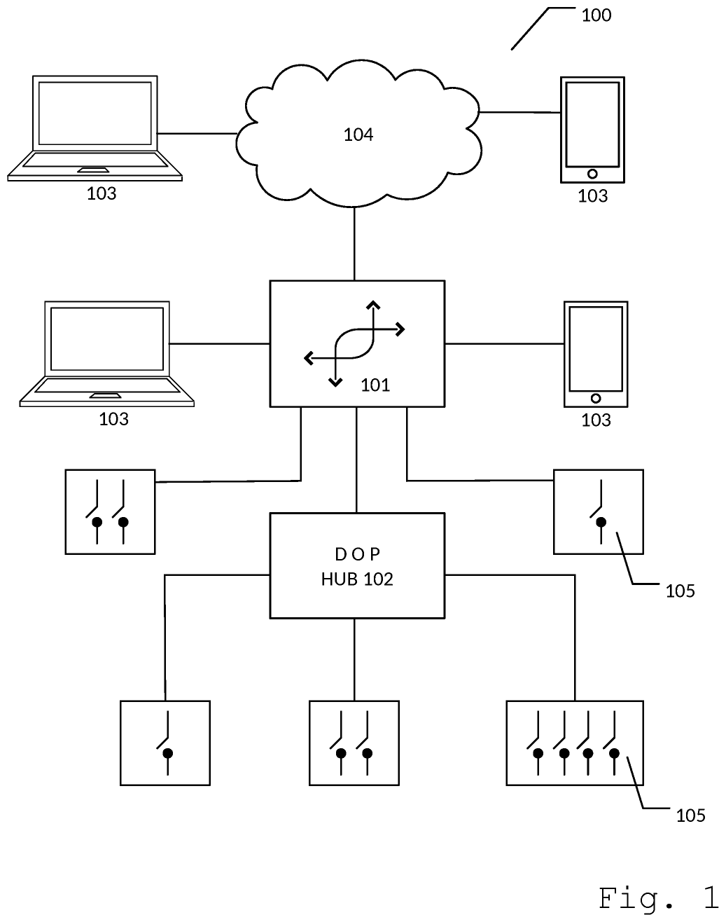

FIG. 1 illustrates a smart switch system 100. In one embodiment, smart switch system 100 can comprise a router 101, a data-over-power (DOP) hub 102, one or more mobile devices 103, one or more smart switch modules 105 connected via a network 104. Router 101 can be a device that manages traffic in a local network and connects the local network to network 104. Each mobile device 103 can be a desktop computer, laptop, tablet, or smartphone capable of receiving, storing, and sending information using a local network and/or network 104. Network 104 can be a local area network (LAN), a wide area network (WAN), a piconet, or a combination of LANs, WANs, or piconets. One illustrative LAN is a network within a single business. One illustrative WAN is the Internet. In a preferred embodiment, network 104 can comprise the Internet.

Each smart switch module 105 can facilitate control of a single device or multiple devices connected to a power circuit, using standard light switches as well as smart control means. A standard light switch operates a device by manually turning a switch on or off to connect or disconnect electricity to a device. One example of a standard light switch is a Leviton® 1451 2WM 15 Amp, 120 Volt, toggle framed single-pole AC quiet switch. Another example of a standard light switch is a Leviton® 1222-2GY 20 Amp, 120/277 Volt, toggle double-pole AC quiet switch. In one embodiment, smart switch modules 105 can connect to router 101 via a Wi-Fi connection. In such embodiment, mobile devices 103 can send data such as instructions to smart switch modules 105 through Wi-Fi connection. In another embodiment, smart switch modules 105 can be connected to network 104 through DOP hub 102. In such embodiment, DOP hub 102 can be connected to network 104 through router 101. In such embodiment, data from mobile devices can be communicated to smart switch module 105 through DOP hub 102. In one embodiment, each smart switch module 105 can be used to control operations of a single device ordinarily controlled by a standard light switch. In another embodiment, each smart switch module 105 can be used to control operations of multiple devices.

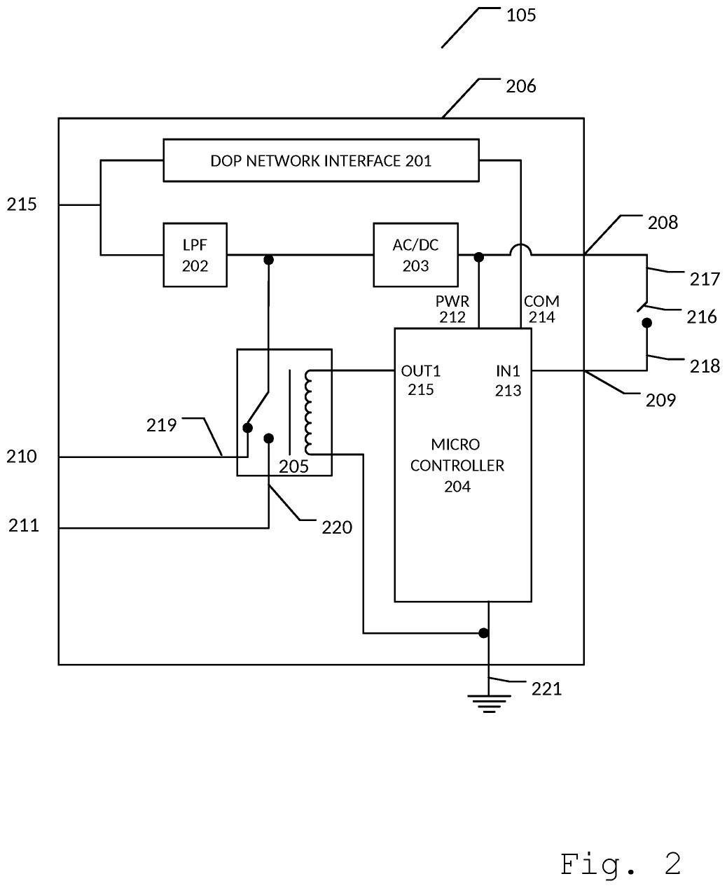

FIG. 2 illustrates a circuit diagram of smart switch module 105 that can be used to control power to a single device. Smart switch module 105 can comprise a network interface, in this embodiment, a DOP network interface 201. Smart switch module 105 can further comprise a low-pass filter (LPF) 202, a rectifier 203, a microcontroller 204, and a first relay 205. All such components can be housed within an enclosure 206.

Enclosure 206 can comprise a plurality of terminals, including, but not limited to an alternating current (AC) input terminal 207, a first direct current (DC) output terminal 208, a first control input terminal 209, and a first AC output terminal 210. In one embodiment, enclosure 206 can also comprise a first AC ALT output terminal 211. Such terminals can all be accessible from an exterior of enclosure 206.

DOP network interface 201 can facilitate communication between smart switch module 105 and DOP hub 102. In one embodiment, DOP network interface 201 can comprise a high pass filter in another embodiment high pass filter can be a separate component. Such high-pass filter can allow communication signals from DOP hub 102 to pass while blocking AC power typically at 50-60 Hz. LPF 202 can be a filter that can pass signals with a frequency lower than a selected cutoff frequency such as AC power, and attenuates signals with frequencies higher than the cutoff frequency such as communication signals. The AC power can pass through LPF 202, to power one or more relays 205 and to be rectified using a rectifier 203. The AC power that goes through rectifier 203 is converted to DC power, and such power is used to power a microcontroller 204 and provide logic control voltage to DC output terminal 208.

Microcontroller 204 can be one or more integrated circuits or plurality of chips comprising a processor and a memory, as discussed further below. Microcontroller 204 comprise a plurality of terminals, including a power port 212, a first control input 213, a communication COM port 214, and a first control output 215. First control input 213 can be electrically connected to a first control input terminal 209.

A first standard light switch 216 can comprise a first supply-side terminal 217 and a first load-side terminal 218. First standard light switch 216 can be capable of connecting and disconnecting first supply-side terminal to and from first load-side terminal 217. First DC output terminal 208 is connectable with first supply-side terminal 217 while first control input terminal 209 is connectable with first load-side terminal 218. In one embodiment, first standard light switch 216 can be an ON/OFF switch. In such embodiment, first standard light switch 216 can be electrically connected and disconnected to first DC output terminal 208 and first DC control input 213 such that when first standard light switch 216 is open, the voltage at input port is a logical low (0), and when first standard light switch 216 is closed, the voltage at input port is a logical high (1). In another embodiment, first standard light switch 216 can be a dimmer switch. In such, embodiment, first control input 213 can receive a control voltage in a range such as between 0 and the DC voltage put out by rectifier 203.

As configured, microcontroller 204 can know first light switch status and can detect a first light switch status change. Similarly, microcontroller 204 can receive instructions from COM port 214. Based on first light switch status and instructions from COM port 214, microcontroller 204 can control first relay 205 using first control output 215, as will be further described below.

First relay 205 is a switch that can be activated by a signal. First relay 205 can comprise a first relay AC output 219 in electrical connection with first AC output terminal 210. In an embodiment wherein first relay 205 is a two-pole relay, first relay 205 can further comprise a first AC ALT output 220 in electrical connection with AC ALT output terminal 211. In such embodiment, when AC output terminal 210 is ON, AC ALT output terminal 211 is OFF, and when AC output terminal 210 is OFF, AC ALT output 211 is ON. When smart switch module 105 comprises first relay 205 that is double-pole, smart switch module 105 can be used in a three-way or a four-way circuit as long as smart switch module is the dominant switch, i.e., the switch connected to directly to the hot line coming from a panel (as opposed to from another switch).

For purposes of this disclosure, first relay 205 can comprise a relay driver. While microcontroller 204 provides a control signal, a relay driver can, in response to the control signal, provide sufficient power to drive a relay. First relay 205 can be an electromechanical relay or a solid-state relay or switch. An example of such solid-state devices is a metal-oxide semiconductor field-effect transistor (MOSFET). In one embodiment, a user can operate a device either by manually changing the position of standard light switch 216 or sending an instruction using mobile device 103 to change the state of smart switch module 105. For example, when a user changes the state of standard light switch 216, microcontroller 204 receives a change in voltage at first control input 213. Per programming stored in microcontroller 204, when standard light switch 216 changes states, microcontroller 204 can send a signal from first control output 215 to change the state of first relay 205. Similarly, when a user sends an instruction from mobile device 103, such instruction is received by DOP network interface 201 where it is converted into a format readable by microcontroller 204, and forwarded to microcontroller 204. Per programming stored in microcontroller 204, upon receiving the instruction, microcontroller 204 can send a signal from first control output 215 to change the state of first relay 205. Changing the state of first relay 205 can include changing the position of as switch within first relay 205, or changing an output voltage of first relay 205, if such relay is a solid-state device that allows for a range of output voltages based on another range of outputs from first control output 215. Enclosure 206 can also comprise a ground terminal 221

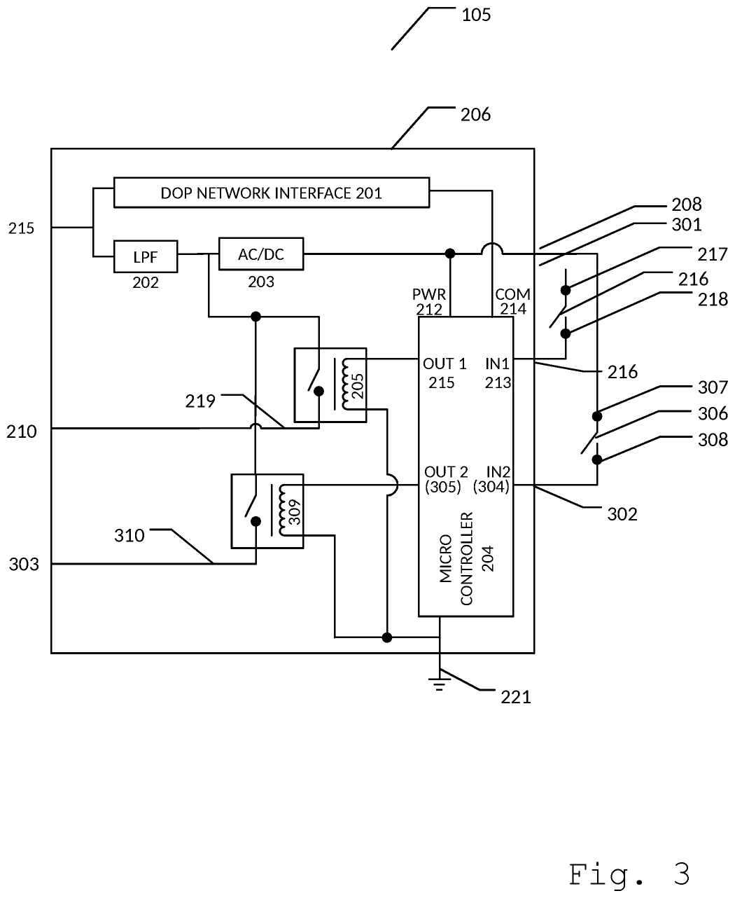

FIG. 3 illustrates another circuit diagram of smart switch module 105 that can be used to control multiple devices, each by a dedicated standard light switch and by mobile devices. In one embodiment, enclosure 206 can be configured similarly to the embodiment FIG. 2, but be configured to operate multiple devices. For example, enclosure 206 can comprise a plurality of terminals, including, but not limited to alternating current (AC) input terminal 207, first DC output terminal 208, second DC output terminal 301, first control input terminal 209, a second control input terminal 302, first AC output terminal 210, and a second AC output terminal 303. In one embodiment, enclosure 206 can also comprise first AC ALT output terminal 211 and a second AC ALT output terminal. Such terminals can all be accessible from enclosure 206.

Microcontroller 204 comprise a plurality of terminals, including power port 212, first control input 213, second control input 304, communication (COM) port 214, first control output 215, and a second control output 305. First control input 213 can be electrically connected to a first control input terminal 209. Second control input 304 can be electrically connected to second control input terminal 302.

A second standard light switch 306 can comprise a second supply-side terminal 307 and a second load-side terminal 308. First standard light switch 216 can be capable of connecting and disconnecting second supply-side terminal 307 to and from second load-side terminal 308. Second DC output terminal 301 is connectable with second supply-side terminal 307 while second control input terminal 302 is connectable with second load-side terminal 308. In one embodiment, second standard light switch 306 can be an ON/OFF switch. In such embodiment, second standard light switch 306 can electrically connected and disconnected second DC output terminal 301 and second control input terminal 302 such that when second standard light switch 306 is open, the voltage at input port is a logical low (0), and when second standard light switch 306 is closed, the voltage at input port is a logical high (1). In another embodiment, second standard light switch 306 can be a dimmer switch. In such, embodiment, second control input 304 can receive a control voltage in a range such as between 0 and the DC voltage put out by rectifier 203.

As configured, microcontroller 204 can know second light switch status and can detect a second light switch status change. Similarly, microcontroller 204 can receive instructions from COM port 214. Based on second light switch status and instructions from COM port 214, microcontroller 204 can control a second relay 309 using a second control output 305, as will be further described below.

Second relay 309 is a switch that can be activated by a signal. Second relay 309 can comprise a second relay AC output 310 in electrical connection with a second AC output terminal 303. In an embodiment wherein second relay 309 is a two-pole relay, second relay 309 can further comprise a second AC ALT output in electrical connection with second AC ALT output terminal, with similar properties and uses as a two-pole first relay 205 as described above.

For purposes of this disclosure, second relay 309 can comprise a relay driver similar as described above. Similarly, second relay 309 can be an electromechanical relay or a solid-state relay or switch. In one embodiment, a user can operate a second device either by manually changing the position of second standard light switch 306 or sending an instruction using mobile device 103 to change the state of second relay 309. For example, when a user changes the state of second standard light switch 309, microcontroller 204 receives a change in voltage at second control input 305. Per programming stored in microcontroller 204, when standard light switch 216 changes states, microcontroller 204 can send a signal from second control output 305 to change the state of second relay 309. Similarly, when a user sends an instruction from mobile device 103, such instruction is received by DOP network interface 201 where it is converted into a format readable by microcontroller 204, and forwarded to microcontroller 204. Per programming stored in microcontroller 204, upon receiving the instruction, microcontroller 204 can send a signal from second control output 305 to change the state of second relay 309. Changing the state of second relay 309 can include changing the position of as switch within second relay 309, or changing an output voltage of second relay 309, if such relay is a solid-state device that allows for a range of output voltages based on another range of outputs from second control output 305.

Similar to how the embodiment show in FIG. 3 was expanded from FIG. 2 to control two devices, this disclosure contemplates the same principles being used to make embodiments capable of controlling three or more devices in the same manner.

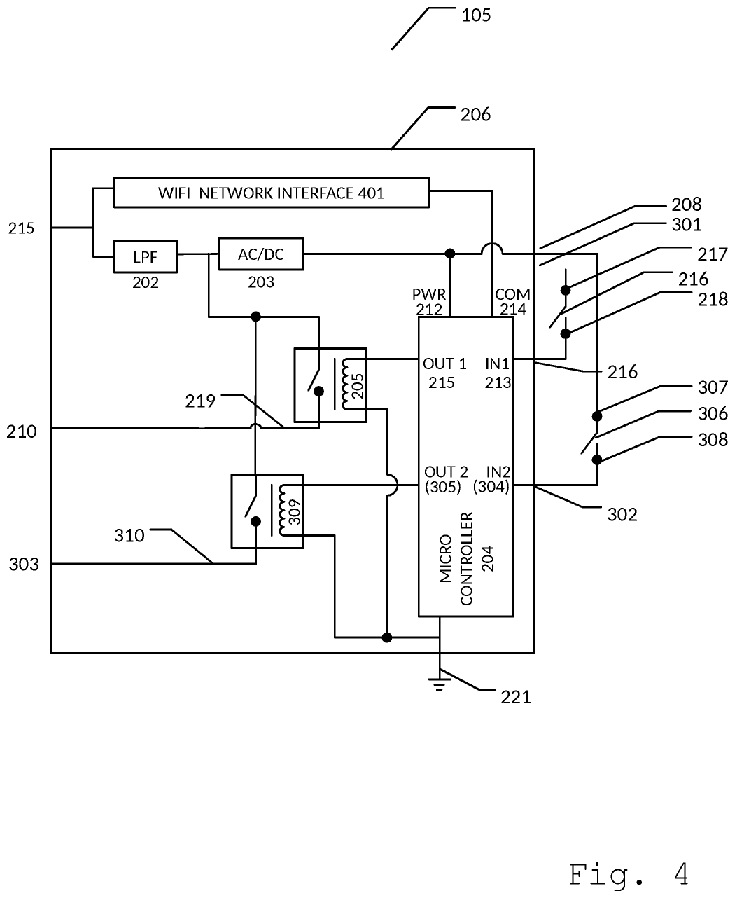

FIG. 4 illustrates another circuit diagram of smart switch module 105 using a WI-FI network interface 401 in lieu of a DOP Network Interface 201. This embodiment can work similar to smart switch module 105 for multiple light switches except that this embodiment uses WI-FI network interface 401 instead of DOP network interface 201. In this example embodiment, smart switch module 105 can comprise WI-FI network interface 401, rectifier 203, microcontroller 204, and relays 205. WI-FI network interface 401 can allow smart switch module 105 to communicate with router 101, thereby transmitting statuses to and receiving instructions from mobile device 103.

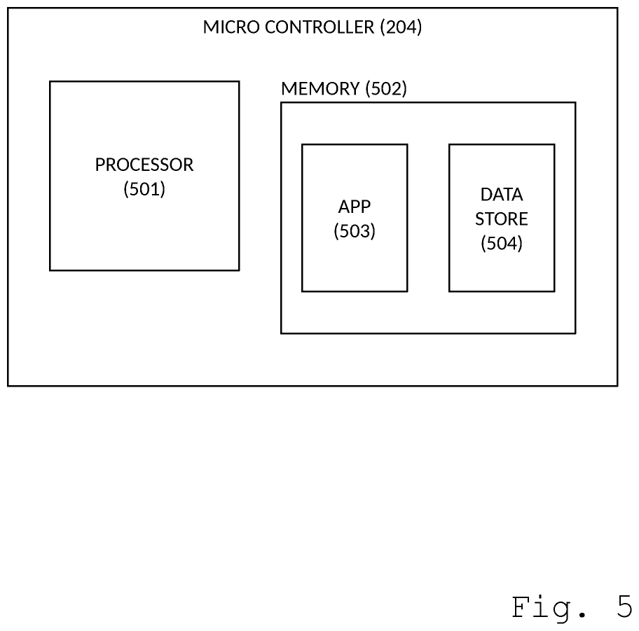

FIG. 5 illustrates a schematic diagram of microcontroller 204 according to an embodiment of the present disclosure. In this embodiment, microcontroller 204 can comprise a processor 501 and a memory 502. Processor 501 performs instructions stored within memory 502. Memory 502 can comprise an application 503 and data storage 504. Application 503 can reside and perform logical functions within memory 502. Examples of logical functions performed by application are monitoring first control input 213 and second control input 302 for status changes of first standard light switch 216 and second standard light switch 306, and changing a position of first relay 205 and/or second relay 309 based on the status change(s). Application 503 can receive and transmit sets of instructions and data information across network 104. For example, application 503 can receive instructions from mobile device 103 to change the position of firs relay 205 or second relay 309. Application 503 can also transmit a status. Data storage 504 can be a component in memory 502 that can be used to retain digital data.

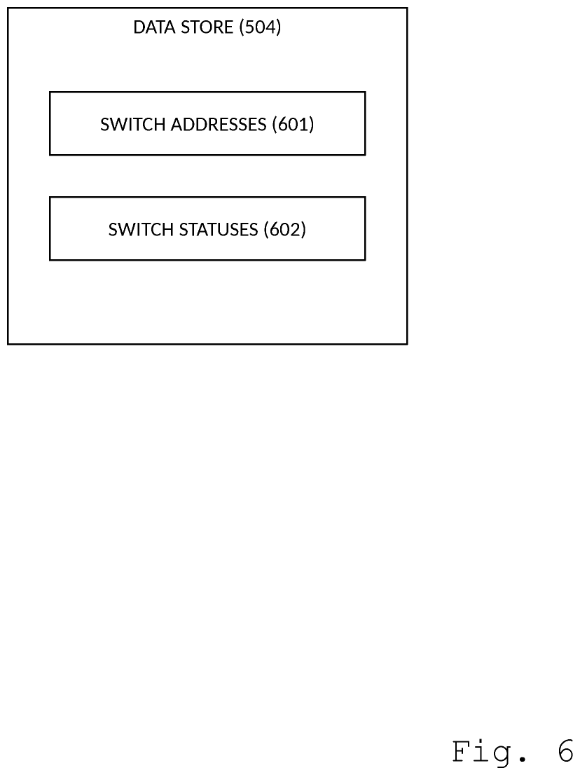

FIG. 6 illustrates data store 504 comprising one or more switch addresses 601 and one or more switch statuses 602. Switch addresses 601 can be a unique address for each light switch 206, while switch statuses 602 can be the status of each light switch 206. Moreover, each switch address 601 can be related to each switch status 602. Further in one embodiment, data store 504 can also comprise a predetermined time 603. Predetermined time 603 is a buffer time that prevents rapid switching from occurring when first standard light switch 216 or second standard light switch 309 is changing positions by the user.

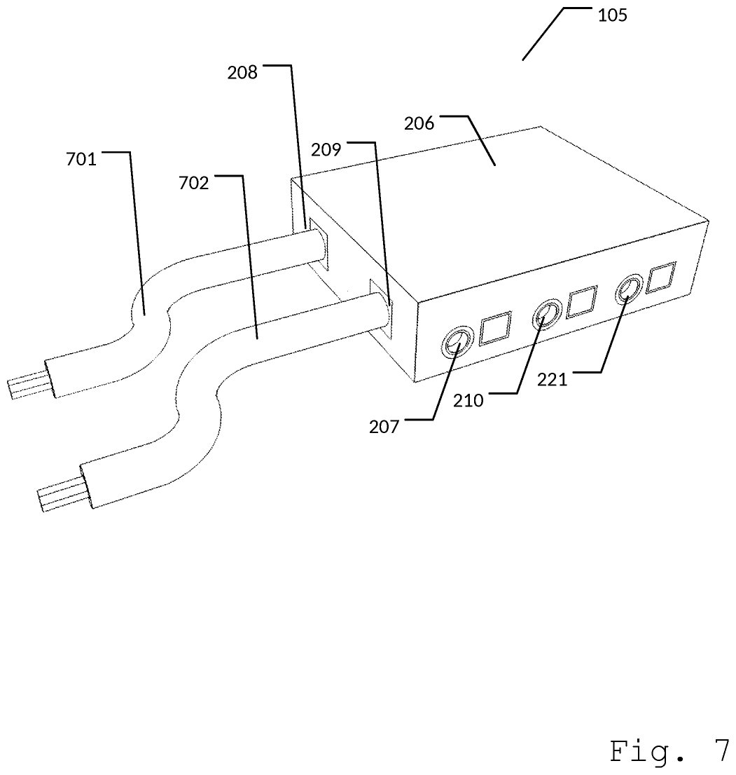

FIG. 7 illustrates an embodiment of smart switch module 105 for controlling a single device with first single standard light switch 216, smart switch module 105 comprising relay 205 with a single pole. In one embodiment, enclosure 206 can be rectangular in shape such that first DC output terminal 208, AC input terminal 207, first AC output terminal 210, and first control input terminal 209 can be placed within the same horizontal plane of enclosure 206. In a preferred embodiment, first DC output terminal 208 can comprise a first wire 701 extending from enclosure 206 and connectable to a first lead of first standard light switch 216. Further, first control input terminal 209 can comprise a second wire 702 connectable to a second lead of standard light switch 216. When connected to first DC output terminal 208 and first control input 213 as described, standard light switch 216 can operate to connect and disconnect First DC output terminal 208 from first control input 213. Also, in a preferred embodiment, AC input terminal 207, and first AC output terminal 210 can each comprise a terminal capable of connecting to a wire. Such terminal can be any terminal known in the art. One example of a terminal is a socket. A socket can receive a wire and hold it in place. In one embodiment, a socket can comprise a release mechanism such as a button to allow the wire to be removed from the socket. Another example of a terminal is a screw that when screwed in, holds a wire in place. In another embodiment, First DC output terminal 208 and first control input 213 can be terminals. Further, in another embodiment, AC input terminal 207 and/or first AC output terminal 210 can each comprise a wire extending from enclosure 206. Enclosure 206 can also comprise grounding terminal 221.

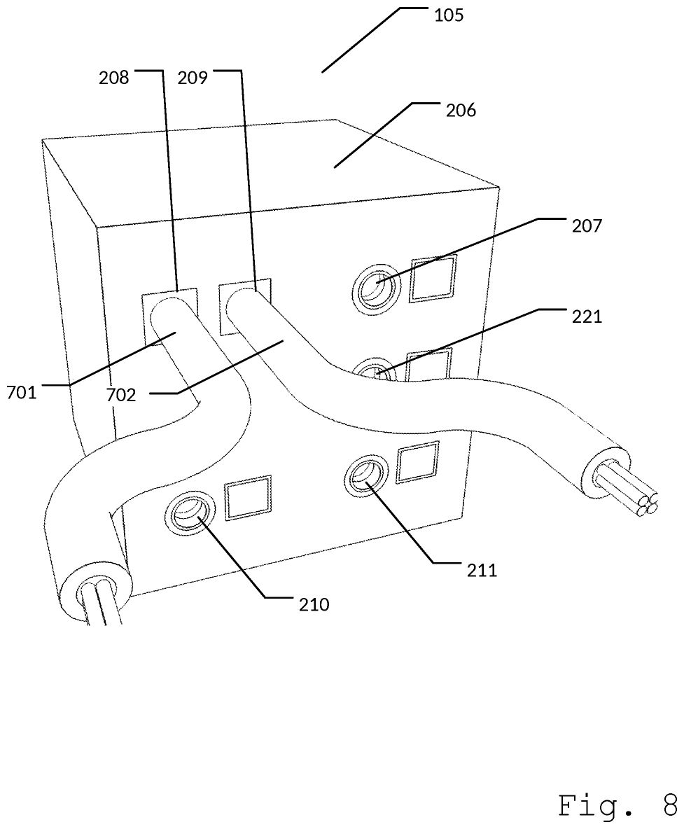

FIG. 8 illustrates another embodiment of smart switch module 105 for controlling a single device with a single standard light switch 216, smart switch module 105 comprising relay 205 with two poles. In this embodiment, first DC output terminal 208, first control input 213, AC input terminal 207, first AC output terminal 210, and first AC ALT output terminal 211 can be placed at the exterior of enclosure 206. As enclosure 206 would typically be mounted within a switch box, enclosure 206's shape and size are based on constraints of a switch box to which a user would mount one or more standard light switches.

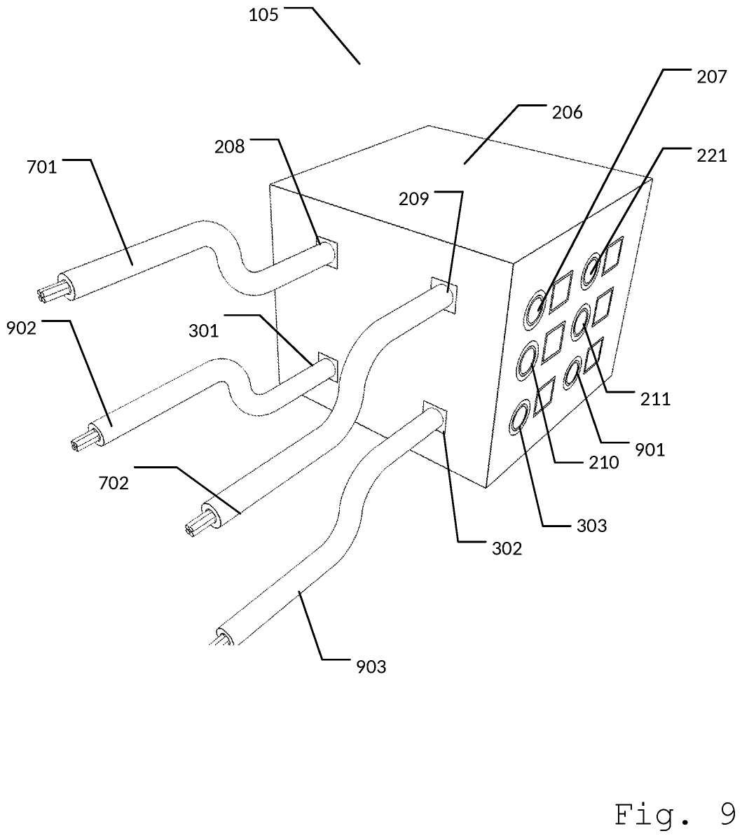

FIG. 9 illustrates an embodiment of smart switch module 105 capable of controlling multiple devices and connecting with multiple standard light switches. As shown in FIG. 9, enclosure 206 can comprise a plurality of terminals accessible from its exterior, including, but not limited to alternating current (AC) input terminal 207, first DC output terminal 208, second DC output terminal 301, first control input terminal 209, second control input terminal 302, first AC output terminal 210, second AC output terminal 303, first AC ALT output terminal 211 and a second AC ALT output terminal 901. In a preferred embodiment, first DC output terminal 208 can comprise a first wire 701 extending from enclosure 206 and connectable to first supply-side terminal 217 of first standard light switch 216. Further, first control input terminal 209 can comprise a second wire 702 connectable first load-side terminal 218 of first standard light switch 216. Second DC output terminal 301 can comprise a third wire 902 extending from enclosure 206 and connectable to a second supply-side terminal 307 of second standard light switch 306. Further, second control input 302 can comprise a fourth wire 903 connectable to a second load-side terminal 308 of second standard light switch 306. When connected to first DC output terminal 208 and first control input terminal 209 as described, first standard light switch 216 can operate to connect and disconnect first DC output terminal 208 from first control input terminal 209. Similarly, when connected to second DC output terminal 301 and second control input terminal 302 as described, second standard light switch 306 can operate to connect and disconnect second DC output terminal 301 from second control input terminal 302. Also, in a preferred embodiment, (AC) input terminal 207, AC output terminal 210, second AC output terminal 303, first AC ALT output terminal 211, and a second AC ALT output terminal 901 can each comprise a terminal capable of connecting to a wire. Such terminal can be any terminal known in the art, such as a socket as described above. In another embodiment, first DC output terminal 208, second DC output terminal 301, first control input 208, and second control input 302 can be terminals. Further, in another embodiment, (AC) input terminal 207, AC output terminal 210, second AC output terminal 303, first AC ALT output terminal 211, and a second AC ALT output terminal 901 can each comprise a wire extending from enclosure 206.

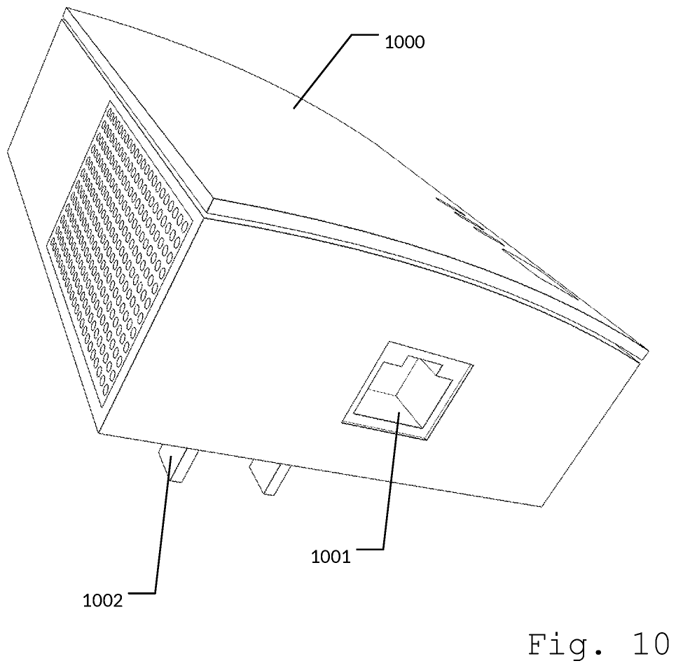

FIG. 10 illustrates DOP hub 102. DOP hub 102 connects smart switch module 105 to a network. DOP hub 102 comprises an Ethernet port 1001 and a wall plug 1002. DOP hub receives power via wall plug 1002 and also receives communication signals from smart switch module 105 via wall plug 1002. Ethernet port then takes these communications signals and sends them over network to their destinations such as a server or a mobile device. In one embodiment, DOP hub 102 can comprise a memory that stores statuses of first relay 205 and relay 309 of smart switch modules 105 to which it is connected.

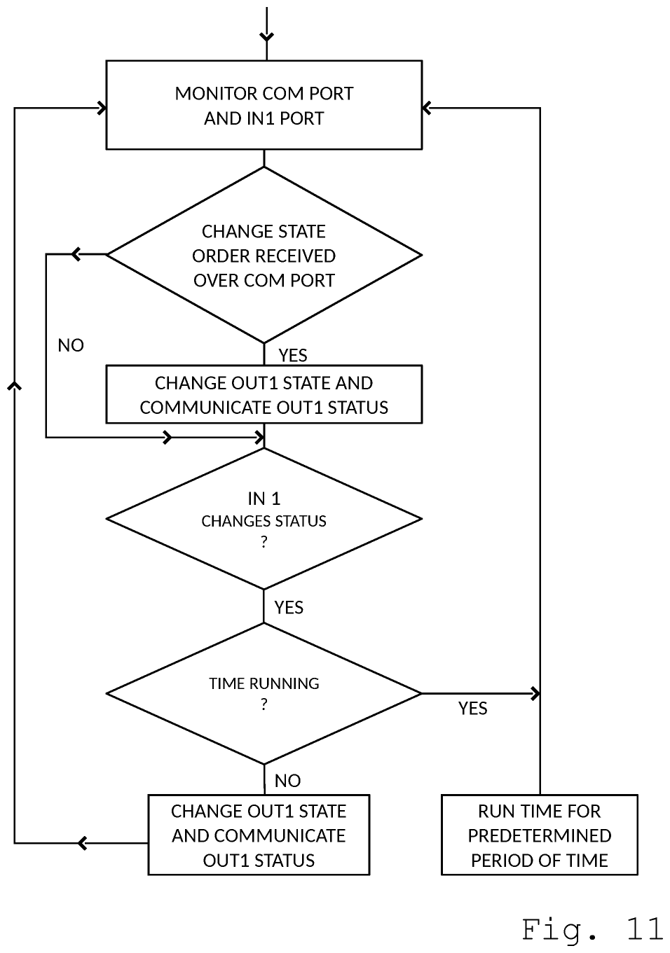

FIG. 11 illustrates an exemplary method of operation of smart switch module 105. Once smart switch module 105 is installed, microcontroller 204 on smart switch module 105 can monitor information coming from COM port 214 and first control input 213. In a scenario wherein microcontroller 204 does not receive an instruction from COM port 214 or a change in state from first control input 213, then first control output 215 does not change. In another scenario wherein microcontroller 204 receives a signal from COM port 214 or a change in state from first control input 213, then first control output 215 can be changed. In such scenario, switch status 602 related to switch address 601 of the standard light switch can be updated and microcontroller 204 can communicate an updated first control output 215 to relay 205.

In one embodiment a predetermined period of time can exist and begin running when relay is switched. For such period of time, anywhere from a few milliseconds to a second, any additional switching from first standard light switch 216 will not cause microcontroller 204 to change the position of first relay 205 or value of switch status 602. A purpose of this method is to prevent rapid switching from noise during switching. A similar method can bew applied with second light switch 306 and second relay 309.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A smart switch module comprising
an enclosure
an alternating current (AC) input terminal accessible from an exterior of said enclosure
a first DC output terminal accessible from said exterior of said enclosure, said first DC output terminal connectable to a first supply-side terminal of a first standard light switch;
a first control input terminal accessible from said exterior of said enclosure, said first control input terminal connectable to a first load-side terminal of said first standard light switch, said first standard light switch capable of connecting and disconnecting said first supply-side terminal to and from said first load-side terminal;
a first AC output terminal accessible from said exterior of said enclosure;
a first relay comprising
a first relay AC output in electrical connection with said first AC output terminal
a microcontroller within said enclosure, said microcontroller comprising
a first control input in electrical connection with said first DC output terminal,
a first control output capable of controlling a first state of said first relay
a memory comprising an application and data storage; and
a processor that, in accordance with said application changes said first state of said first relay upon detecting a first light switch status change.

2. The smart switch module of claim 1 wherein said first relay is a solid-state relay.

3. The smart switch module of claim 2 wherein changing said first state of said first relay causes a voltage at said first AC output terminal to vary within a voltage range.

4. The smart switch module of claim 2 wherein changing said first state of said first relay causes a voltage at said first AC output terminal to change to ON if prior to changing it was OFF and OFF if prior to changing it was ON.

5. The smart switch module of claim 1 further comprising a first AC ALT output terminal accessible from said exterior of said enclosure, said first relay further comprising a first relay AC ALT output in electrical connection with said first AC ALT output terminal, further wherein when AC output terminal is ON, AC ALT output terminal is OFF, and when AC output terminal is OFF, AC ALT output is ON.

6. The smart switch module of claim 1 wherein said microcontroller further comprises a communication port capable of receiving an instruction to change said first status from a network interface.

7. The smart switch module of claim 6 wherein said network interface is a data-over-power (DOP) network interface.

8. The smart switch module of claim 7 wherein said DOP network interface comprises a high-pass filter.

9. The smart switch module of claim 6 wherein said network interface is a Wi-Fi network interface.

10. The smart switch module of claim 1 wherein said first relay comprises a relay driver.

11. The smart switch module of claim 1 wherein
said first DC output terminal comprises a first wire extending outside said enclosure and
said first control input terminal comprises a second wire extending outside said enclosure.

12. The smart switch module of claim 1 wherein
said alternating current (AC) input terminal comprises a first socket capable of receiving a supply wire; and
said first AC output terminal comprises a second socket capable of receiving a wire load wire.

13. The smart switch module of claim 1 further comprising
a second DC output terminal accessible from said exterior of said enclosure, said second DC output terminal connectable to a second supply-side terminal of a second standard light switch;
a second control input terminal accessible from said exterior of said enclosure, said second control input terminal connectable to a second load-side terminal of said second standard light switch, said second standard light switch capable of connecting and disconnecting said second supply-side terminal to and from said second load-side terminal;
a second AC output terminal accessible from said exterior of said enclosure;
a second relay comprising a second relay AC output in electrical connection with said second AC output terminal; and
wherein said microcontroller further comprises
a second control input in electrical connection with said second DC output terminal, and
a second control output capable of controlling a second state of said second relay, and
further wherein said processor, in accordance with said application changes said second state of said second relay upon detecting a second light switch status change.

14. A method for controlling a device using a smart switch comprising
connecting a standard light switch to a smart module, said standard light switch module,
said standard light switch comprising
a supply-side terminal and
a load-side terminal, said first standard light switch capable of connecting and disconnecting said first supply-side terminal to and from said first load-side terminal,
said smart switch module comprising
an enclosure
an alternating current (AC) input terminal accessible from an exterior of said enclosure
a first DC output terminal accessible from said exterior of said enclosure, said standard light switch connecting to said smart switch module by connecting said first DC output terminal to said first supply-side terminal;
a first control input terminal accessible from said exterior of said enclosure, said standard light switch further connecting to said smart switch module by connecting said first control input terminal to said first load-side terminal;
a first AC output terminal accessible from said exterior of said enclosure;
a first relay comprising
a first relay AC output in electrical connection with said first AC output terminal
a microcontroller within said enclosure, said microcontroller comprising
a first control input in electrical connection with said first DC output terminal,
a first control output capable of controlling a first state of said first relay;
a memory comprising an application and data storage; and
a processor
detecting by said microcontroller a first light switch status change of said first standard light switch; and
changing, using said microcontroller, said first state of said first relay upon detecting said first light switch status change.

15. The method of claim 14 further comprising maintaining said first state for a predetermined period of time after changing said first state.

16. The method of claim 14 wherein said microcontroller further comprises a communication port capable of receiving an instruction to change said first state from a network interface.

17. The method of claim 16 further comprising the step of
receiving said instruction; and
change said first state based on said instruction.

18. The method of claim 17 wherein said network interface is a DOP network interface.

19. The method of claim 17 wherein said network interface is a Wi-Fi network interface.

20. The method of claim 12 further comprising the step of disconnecting said standard light switch from said smart switch module.
